(19) United States
(12) Patent Application Publication
(10) Pub. No.: US 2025/0180705 A1
(43) Pub. Date: Jun. 5, 2025

(54) OPTICAL APPARATUS, ON-BOARD SYSTEM, AND MOVABLE APPARATUS

(71) Applicant: CANON KABUSHIKI KAISHA, Tokyo (JP)

(72) Inventors: SHUNICHI WAKASHIMA, Tokyo (JP); KOICHI FUKUDA, Tokyo (JP); KOHEI OKAMOTO, Kanagawa (JP); TAKASHI HANASAKA, Tokyo (JP)

(21) Appl. No.: 19/045,172

(22) Filed: Feb. 4, 2025

Related U.S. Application Data
(63) Continuation of application No. PCT/JP2023/024309, filed on Jun. 30, 2023.

(30) Foreign Application Priority Data
Sep. 13, 2022 (JP) 2022-145543

(51) Int. Cl. G01S 7/481; G01S 7/4865; G01S 7/499; G01S 17/14; G01S 17/894; G01S 17/931

(52) U.S. Cl. CPC G01S 7/4811; G01S 7/4866; G01S 7/499; G01S 17/14; G01S 17/894; G01S 17/931

(57) ABSTRACT

An optical apparatus includes a light emitting unit including light emitting elements, a light receiving unit including light receiving elements, an imaging optical system, a light division unit including a reflector, and an acquisition unit that acquires distance information of an object based on a time that is required from emission of light to reception of light reflected by the object, the light from the light emitting unit is reflected by the reflector to pass through the imaging optical system to be reflected by the object, light reflected by the object passes through the imaging optical system to transmit through the reflector to be received by the light receiving unit, a first light emitting element and a first light receiving element are in a conjugate relationship via the reflector, and the light division unit suppresses light from the first light emitting element from entering the first light receiving element.

### CROSS-REFERENCE TO RELATED APPLICATIONS

This application is a Continuation of International Patent Application No. PCT/JP2023/024309, filed on Jun. 30, 2023, which claims the benefit of Japanese Patent Application No. 2022-145543, filed on Sep. 13, 2022, which is hereby incorporated by reference herein in their entirety.

### BACKGROUND

### Technical Field

The disclosure relates to an optical apparatus, an on-board system (or in-vehicle system), and a movable apparatus.

### Description of Related Art

A time-of-flight (TOF) distance measurement method has been known that measures a distance to an object by measuring a time difference from when light is irradiated onto the object to when reflected light from the object is detected. Japanese Patent Application Laid-Open No. 2019-60652 discloses a configuration that includes light emitting elements and light receiving elements that are two-dimensionally arranged, wherein light is irradiated onto an object through an imaging lens, reflected light from the object is received, and three-dimensional distance information is acquired without a driving unit. This configuration requires an angle of view of the emitted light and an angle of view of the received light to be approximately equal. Thus, in order to reduce the size of the distance measuring apparatus, the light emitting element array and the light receiving element array may have approximately the same sizes and share the imaging lens.

Japanese Patent Application Laid-Open No. 2021-021597 discloses a configuration for generating a third time-series luminance signal by subtracting a second time-series luminance signal depending on reflected light from outside a measurement object from a first time-series luminance signal depending on reflected light from the measurement object, and generating a distance value to the measurement object based on the third time-series luminance signal.

In the configuration disclosed in Japanese Patent Application Laid-Open No. 2021-021597, a plurality of mirrors are arranged in an optical path, making it difficult to reduce the effect of the reflected light without increasing the size of an apparatus.

### SUMMARY

An optical apparatus according to one aspect of the disclosure includes a light emitting unit including a plurality of light emitting elements arranged in a two-dimensional shape, a light receiving unit including a plurality of light receiving elements, an imaging optical system, a light division unit arranged between the imaging optical system and the light receiving unit, the light division unit including a reflector, and an acquisition unit configured to acquire distance information of an object based on a time that is required from emission of light by the light emitting unit to reception of light reflected by the object by the light receiving unit, a light emitting element in a first row and a light emitting element in a second row of the plurality of light emitting elements emit light at different times from each other in a time-division manner, an optical axis direction of the imaging optical system and a normal direction of the reflector are not parallel, the light from the light emitting unit is reflected by the reflector to pass through the imaging optical system to be reflected by the object, light reflected by the object passes through the imaging optical system to transmit through the reflector to be received by the light receiving unit, a first light emitting element of the plurality of light emitting elements and a first light receiving element of the plurality of light receiving elements are in a conjugate relationship via the reflector, and the light division unit is configured to suppress light from the first light emitting element from entering the first light receiving element.

Further features of various embodiments of the disclosure will become apparent from the following description of embodiments with reference to the attached drawings.

### BRIEF DESCRIPTION OF THE DRAWINGS

FIG. 1 is a block diagram of a distance measuring apparatus in each embodiment.

FIG. 2 is a schematic diagram of a light projection unit in each embodiment.

FIG. 3 is a schematic diagram of a measurement unit in each embodiment.

FIG. 4 is a schematic diagram of a pixel in each embodiment.

FIG. 5 is a schematic diagram of a TDC array unit in each embodiment.

FIG. 6 is a schematic diagram of an oscillator in each embodiment.

FIG. 7 is a table illustrating output signals of buffers at each stage and internal signals of oscillators in each embodiment.

FIG. 8 is an explanatory diagram of changes in a cathode potential of a SPAD element, a pixel output signal, a synchronous clock, a synchronous clock count circuit, an output of an oscillation start/stop signal generating circuit, an output of the oscillator, and an oscillation count circuit in each embodiment.

FIG. 9 is an enlarged diagram of a period from time 803 to time 805 in FIG. 8.

FIG. 10 is a block diagram of an oscillation adjustment voltage generating circuit in each embodiment.

FIGS. 11A to 11C are configuration diagrams of a main part of a distance measuring apparatus in a first embodiment.

FIG. 12 is a flowchart illustrating a distance measuring process in each embodiment.

FIGS. 13A to 13C are configuration diagrams of a main part of a distance measuring apparatus in a second embodiment.

FIGS. 14A to 14C are configuration diagrams of a main part of a distance measuring apparatus in a third embodiment.

FIGS. 15A to 15C are configuration diagrams of a main part of a distance measuring apparatus in a fourth embodiment.

FIG. 16 is a configuration diagram of an on-board system having the distance measuring apparatus according to any one of the above embodiments.

FIG. 17 is a schematic diagram of a movable apparatus having the distance measuring apparatus according to any one of the above embodiments.

FIG. 18 is a flowchart illustrating an example of the operation of an on-board system having the distance measuring apparatus according to any one of the above embodiments.

### DETAILED DESCRIPTION

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of embodiments according to the disclosure. Corresponding elements in respective figures will be designated by the same reference numerals, and a duplicate description thereof will be omitted.

### First Embodiment

### Overall Configuration of Distance Measuring Apparatus

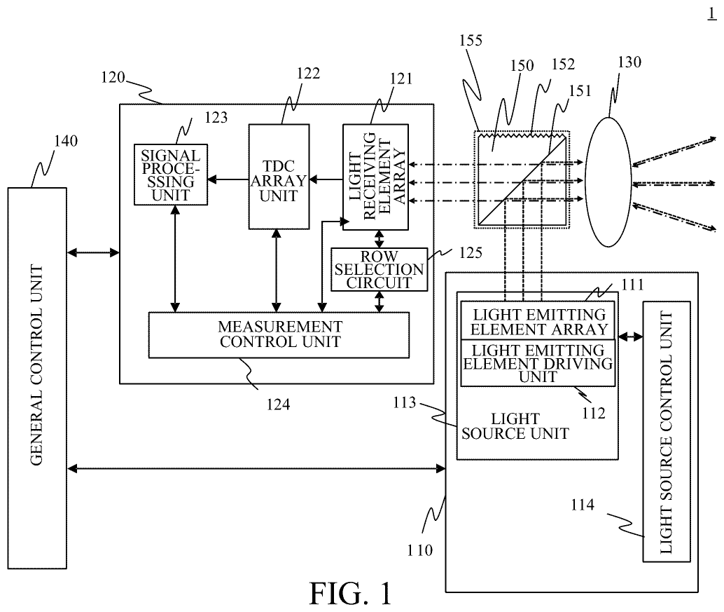

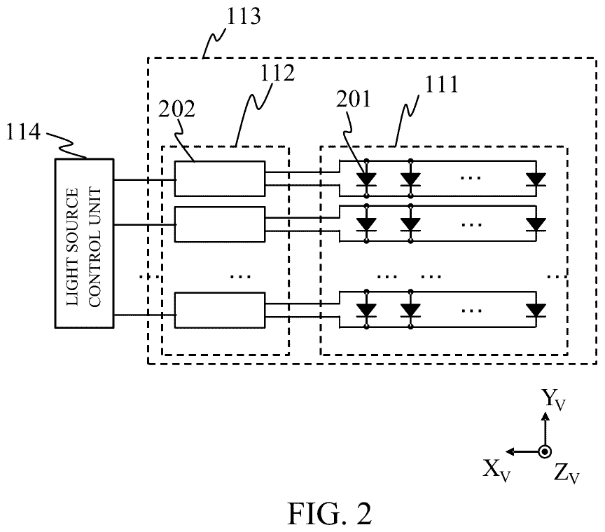

First, referring to FIG. 1, a schematic configuration of an optical apparatus (distance measuring apparatus) 1 in a first embodiment will be described. FIG. 1 is a block diagram of the optical apparatus 1. In FIG. 1, solid lines illustrate communication of signals, dashed lines illustrate projected light onto a subject (object), and dotted lines illustrate reflected light from the subject. The optical apparatus 1 is an optical apparatus (Light Detection and Ranging: LiDAR) that calculates a distance of the object based on the time between the emission of light and the arrival of the light by the TOF method. The optical apparatus 1 includes a light projection unit 110, a measurement unit 120, an imaging lens (imaging optical system) 130, a general control unit 140, and a light division unit 155 including a beam splitter 150. The light projection unit 110 includes a light source unit 113 having a light emitting element array (light emitting unit) 111 and a light emitting element driving unit 112, and a light source control unit 114. The light emitting element array 111 includes a plurality of light emitting elements 201 (see FIG. 2) arranged in a two-dimensional shape. The light emitting element array 111 is a sequential light emitting unit in which some light emitting elements (first row) and the other light emitting elements (second row) of the plurality of light emitting elements 201 emit light at different times from each other in a time-division manner.

The measurement unit 120 includes a light receiving element array (light receiving unit) 121, a TDC (Time-to-Digital Convertor) array unit 122, a signal processing unit 123, a measurement control unit 124, and a row selection circuit 125. The light receiving element array 121 includes a plurality of light receiving elements arranged in a two-dimensional shape. The beam splitter 150 includes a half mirror (reflector) 151 that transmits part of the light and reflects the other part of the light, and a reflection suppression structure 152. In this embodiment, it is preferable to arrange a bandpass filter that transmits light of wavelengths including wavelengths emitted by the light emitting element array 111 and reflects or absorbs light of other wavelengths on the light receiving element array 121.

Each light emitting element array 111 (each of a plurality of light emitting elements 201) in the light source unit 113 emits pulsed light, and the pulsed light is projected into space through the imaging lens 130. The pulsed light emitted from each of the light emitting elements 201 is projected into the space at a different angle of view. The projected light is irradiated onto the subject (object), and part of the light reflected by the subject is received by the light receiving element array 121 via the imaging lens 130. The time from when light is emitted by the light emitting element array 111 to when the light is received by the light receiving element array 121 is the time-of-flight TOF. The TDC array unit 122 is a measurement unit that measures the time-of-flight TOF. However, it is difficult to remove noise components due to noise light such as ambient light and dark counts in a single measurement, and distance measurement errors become large due to the influence of noise in a measurement circuit. For this reason, the TDC array unit 122 repeatedly measures the time-of-flight TOF from emission of the light to reception of the light, and the signal processing unit 123 creates a histogram of the measurement results, removes noise components, and averages the measurement results. The TDC array unit 122 and the signal processing unit 123 constitute an acquisition unit that acquires distance information of the subject based on the time required from the emission of the light by the light emitting element array 111 to the reception of the light reflected by the subject by the light receiving element array 121.

By substituting the time-of-flight TOF obtained in this way into the following equation (1), a distance L to the subject can be determined with high accuracy. In equation (1), symbol c is the speed of light.

$$L = TOF \times c / 2 \qquad ( 1 )$$

### Light Projection Unit

Next, referring to FIG. 2, the light projection unit 110 will be described. FIG. 2 illustrates a schematic diagram of the light source unit 113 and light source control unit 114 that constitute the light projection unit 110. The light emitting element array 111 includes the plurality of light emitting elements 201. In this embodiment, the light emitting element 201 is a VCSEL (Vertical Cavity Surface Emitting LASER) arranged in a two-dimensional shape on a substrate. The light emitting element driving unit 112 includes a plurality of light emitting element row driving circuits 202 arranged in a one-dimensional shape. In this embodiment, the light emitting element 201 is not limited to the VCSEL, but it is preferable to be capable of being integrated in a one-dimensional or two-dimensional manner, such as an end surface emitting laser or LED (light emitting diode).

The light emitting element array 111 is, for example, a laser bar constituted by a one-dimensional array on a substrate or a laser bar stack constituted by a two-dimensional array of the laser bars in a case where the end surface emitting laser is used instead of the VCSEL array as the light emitting element 201. The light emitting element array 111 is an LED arrayed two-dimensionally on a substrate in a case where the LED is used as the light emitting element 201.

In the optical apparatus 1 of this embodiment, it is preferable that the wavelength of the light emitted by the light emitting element 201 is in the near infrared band in order to suppress the influence of ambient light. However, this embodiment is not limited to this. The VCSEL is manufactured using a semiconductor process with materials used in conventional end-emitting lasers and surface emitting lasers. In a case where the VCSEL is configured to emit light in the near infrared wavelength band, GaAs-based semiconductor materials can be used as a main material. In this case, the dielectric multilayer film constituting the DBR (distributed reflector) reflector constituting the VCSEL can be configured by alternately and periodically laminating two thin films (e.g., GaAs/AlGaAs) made of materials with different refractive indices. The wavelength of the emitted light can be changed by adjusting the element combination or composition of the compound semiconductor.

The VCSEL constituting the VCSEL array are provided with electrodes for injecting current and holes into an active layer, and the electrodes are shared in the row direction and connected to the light emitting element row driving circuit 202 arranged in each row. By operating only a specific light emitting element row driving circuit 202 of the light emitting element driving units 112, current is injected only into the VCSEL belonging to a specific row, and it is possible to cause the light emitting elements 201 in the specific row to emit light.

### Measurement Unit

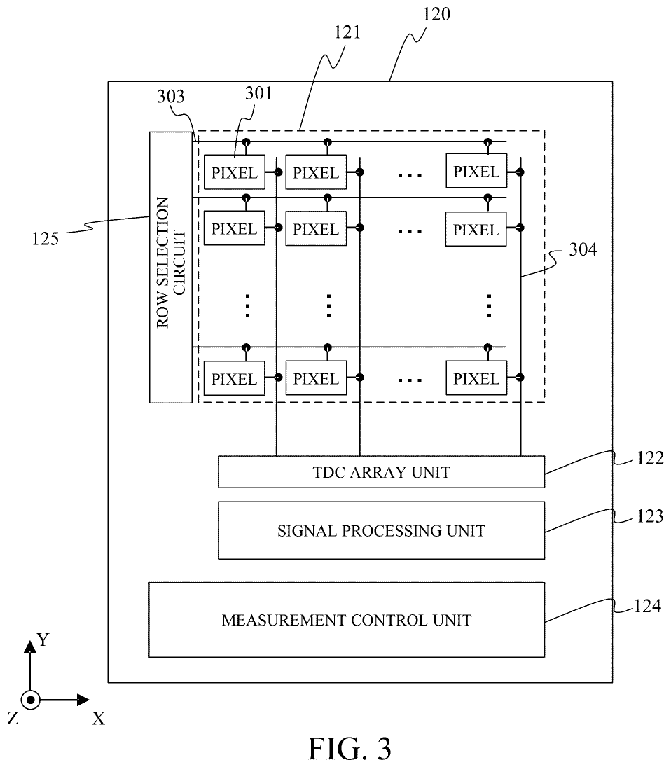

Next, referring to FIG. 3, the measurement unit 120 will be described. FIG. 3 illustrates a schematic diagram of the measurement unit 120. The measurement unit 120 includes the light receiving element array 121, the TDC array unit 122, the signal processing unit 123, the measurement control unit 124, the row selection circuit 125, a row selection pulse lines 303, and a pixel output line 303. The light receiving element array 121 includes a plurality of pixels (light receiving elements) arranged in a two-dimensional shape. The row selection circuit 125 enables only a specific row. The row selection pulse line 303 outputs an output signal of the row selection circuit 125 to the pixel 301. The pixel output line 304 outputs an output signal of the pixel 301 to the TDC array unit 122.

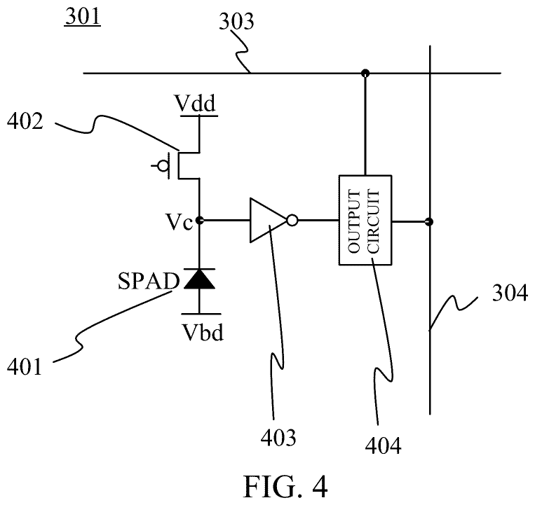

Now, referring to FIG. 4, the pixel 301 in this embodiment will be described. FIG. 4 is a schematic diagram of the pixel 301. The pixel 301 includes a SPAD element 401 as a light receiving element, a load transistor 402, an inverter 403, a pixel output circuit 404, the row selection pulse line 303, and the pixel output line 304. The SPAD element 401 includes a light receiving region and an avalanche region.

In a case where light enters the SPAD element 401, photoelectric conversion occurs in the light receiving region, and electrons and holes are generated. The positively charged holes are ejected through an anode electrode Vbd. Negatively charged electrons, as signal charges, are transported to the avalanche region in the light receiving region by an electric field set so that the potential is lowered toward the avalanche region. The signal charge that reaches the avalanche region causes avalanche breakdown due to the strong electric field in the avalanche region, and an avalanche current is generated.

In a case where no avalanche current is flowing, the voltage of the anode electrode Vbd is set so that a reverse bias above the breakdown voltage is applied to the avalanche region of the SPAD element 401. At this time, since there is no current flowing in the load transistor 402, the cathode potential Vc is close to the supply voltage Vdd, and the inverter output signal is “0”. In a case where the avalanche current is generated in the SPAD element 401 due to the arrival of a photon, the cathode potential Vc drops and the output of inverter 403 reverses. In other words, the inverter output changes from “0” to “1”. As the cathode potential Vc drops, the reverse bias applied to the SPAD element 401 becomes smaller, and the generation of avalanche current stops when the reverse bias falls below the breakdown voltage. Thereafter, a hole current flows from the supply voltage Vdd to the cathode potential Vc via the load transistor 402, the cathode potential Vc rises, and the inverter output returns from “1” to “0” to the state before the arrival of photons.

In the pixel 301 where the row selection pulse line 303 is turned on, the output signal of the inverter 403 is controlled to be output to the pixel output line 304. On the other hand, in the pixel 301 where the row selection pulse line 303 is turned off, the output signal of the inverter 403 is controlled to be disconnected from the pixel output line 304. Therefore, only light incident on a specific row selected by row selection circuit 125 can be detected. The light detection at the pixel belonging to the row selected by row selection circuit 125 is output to the TDC array unit 122 as a low-delay digital signal.

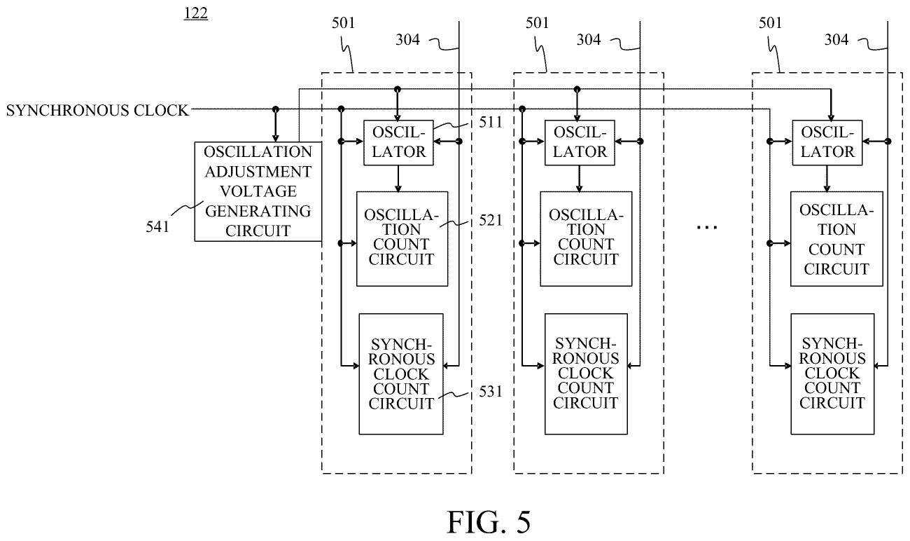

Next, referring to FIG. 5, the TDC array unit 122 will be described. FIG. 5 illustrates a schematic diagram of the TDC array unit 122. The TDC array unit 122 measures the time from when the light source unit 113 emits light to when the pixel output signal changes from “0” to “1” as the ToF time.

In the TDC array unit 122, a TDC 501 is provided for the number of pixels in a horizontal direction of the pixel array, and simultaneously measures pixel output for one row. The TDC 501 has an oscillator 511, an oscillation count circuit 521, and a synchronous clock count circuit 531. The count result of the synchronous clock count circuit 531 is the upper bit, the internal signal of the oscillator 511 is the lower bit, and the count result of the oscillation count circuit 521 is the bit between them. In other words, the synchronous clock count circuit 531 measures roughly, the internal signal of the oscillator 511 measures finely, and the oscillation count circuit 521 measures between them. It is also possible to configure each circuit to have a redundant bit.

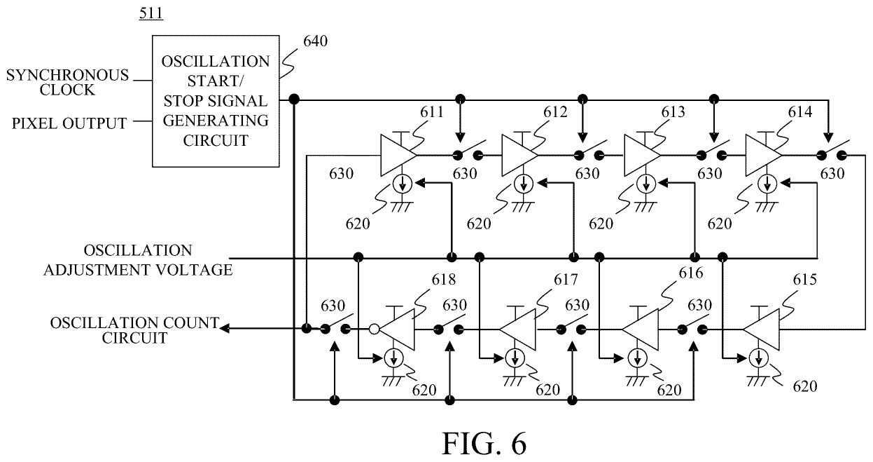

Next, referring to FIG. 6, the oscillator 511 of the TDC 501 will be described. FIG. 6 illustrates a schematic diagram of the oscillator 511. The oscillator 511 includes a oscillation start/stop signal generation circuit 640, buffers 611 to 618, an oscillation switch 630, and a delay adjustment current source 620. The buffers 611 to 618 and the oscillation switch 630 are in loop form, connected alternately for eight stages.

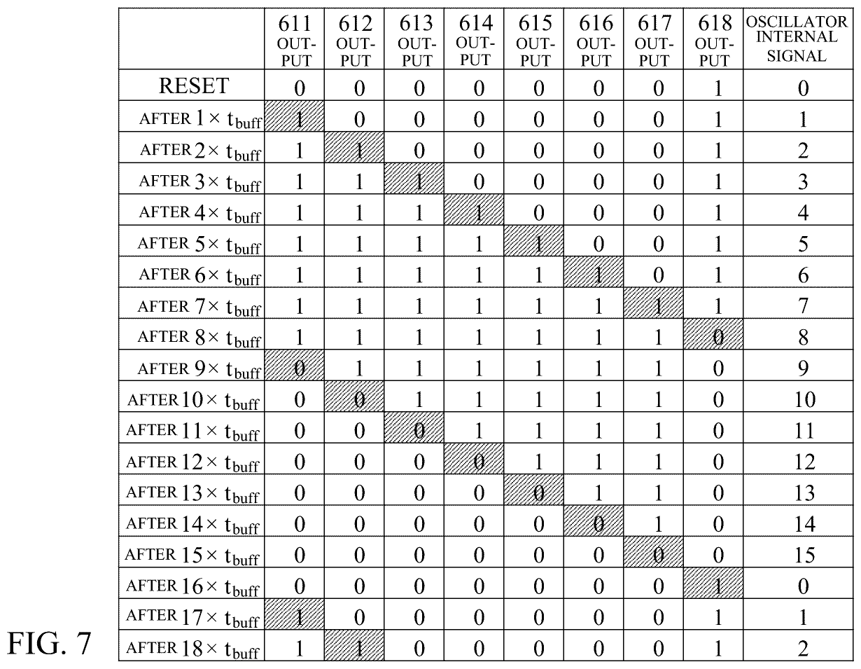

Now, referring to FIG. 7, output signals of the buffers 611 to 618 at each stage and internal signals of the oscillator 511 will be described. FIG. 7 is a table illustrating the output signals of the buffers 611 to 618 at each stage and the internal signals of the oscillator 511 at reset, and the output signals of the buffers 611 to 618 at each stage and the internal signals of the oscillator 511 after a certain time has passed after the oscillation switch 630 is turned on.

At reset, the outputs of the buffers 611 to 617 are “0” and the output of the buffer 618 is “1”. After the delay time t_{buff} for one buffer stage has elapsed since the oscillation switch 630 is turned on, the outputs of the buffers 612 to 618, whose inputs and outputs are in alignment, do not change, and only the output of the buffer 611, whose inputs and outputs are not in alignment, changes from “0” to “1” (the signal advances one stage). Also, after a delay time of t_{buff} for one buffer stage (after 2×t_{buff}), the outputs of the buffers 611 and 613 to 618, whose inputs and outputs are in alignment, remain unchanged, and only the output of the buffer 612, whose inputs and outputs are not in alignment, changes from “0” to “1” (the signal advances by one stage). Thus, every delay time t_{buff} for one buffer stage, the output of one buffer whose inputs and outputs are not in alignment changes in turn. After 8×t_{buf} from when the oscillation switch 630 is turned on, the outputs of all the buffers change (the signal goes around once), and after 16×t_{buf}, all the buffers change again (the signal goes around twice) and return to the original state. After that, the same operation is repeated every 16×t_{buuf} time.

This results in a time measurement with a time resolution of t_{buff}. The time resolution t_{buff} is adjusted to be 1/2⁷ of a synchronous clock by the oscillation adjustment voltage generating circuit 541 described below. The output of the buffer 618, which is the output of the oscillator 511, is input to the oscillation count circuit 521. The oscillation count circuit 521 counts the rising edge of the output of the oscillator 511 to measure time with a time resolution of 16×t_{buff}.

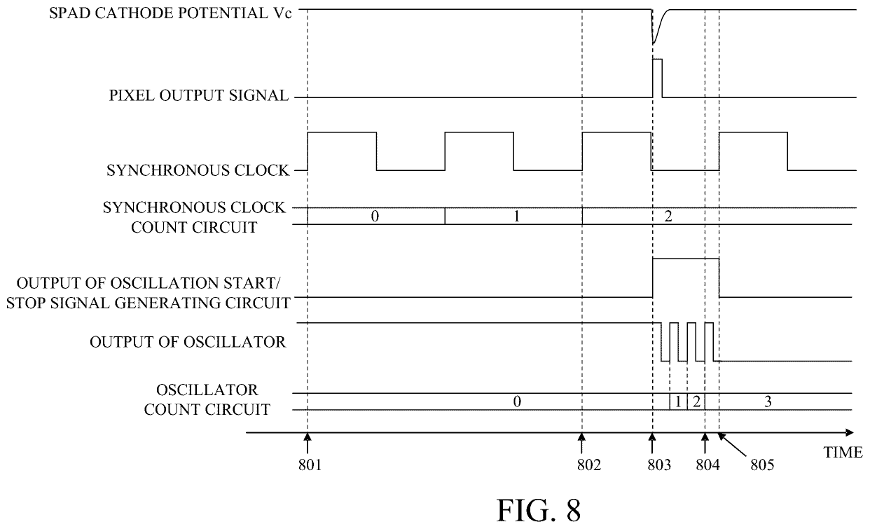

FIG. 8 illustrates the cathode potential Vc of the SPAD element 401, the pixel output signals, the synchronous clock, the synchronous clock count circuit 531, the output of the oscillation start/stop signal generation circuit 640, the output of the oscillator 511, and the oscillation count circuit 521. FIG. 8 illustrates the change in time from when the light emitting element 201 belonging to a specific row of the light emitting element array 111 emits light to when the SPAD element 401 receives the reflected light and the TDC counting operation is completed.

The cathode potential Vc of the SPAD element 401 is an analog voltage, with the upper side of the paper showing the higher voltage. The synchronous clock, the output of the oscillation start/stop signal generation circuit 640, and the output of the oscillator 511 are digital signals, with the upper side of the paper showing on and the lower side of the paper showing off. The synchronous clock count circuit 531 and the oscillation count circuit 521 are digital values and are shown as decimal numbers.

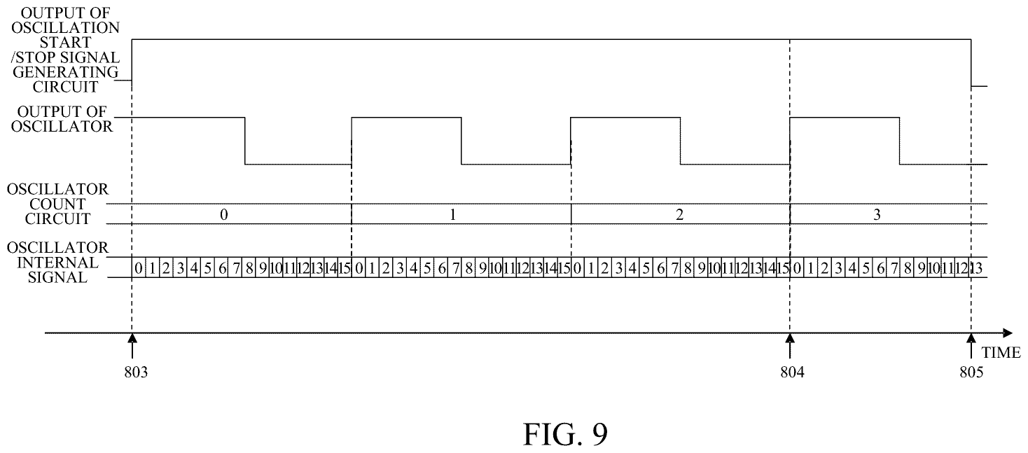

FIG. 9 is an enlarged view from time 803 to time 805 in FIG. 8, illustrating the output of the oscillation start/stop signal generation circuit 640, the output of the oscillator 511, the oscillation count circuit 521, and the internal signals of the oscillator 511. The internal signals of the oscillator 511 are digital values and are shown as decimal numbers.

Referring to FIGS. 8 and 9, the operation of measuring the time from time 801 when the light emitting element 201 belonging to a specific row of the light emitting element array 111 emits light to time 803 when the pixel receives a photon by the TDC 501 will be described.

A specific light emitting element row driving circuit 202 is driven so that the light emitting element 201 belonging to a specific row of the light emitting element array 111 emits light at time 801 coinciding with the rising edge of the synchronous clock supplied via the general control unit 140. The synchronous clock count circuit 531 starts counting the rising edge of the synchronous clock from the time when the light emitting element 201 emits light.

At time 803, the photon reflected from the subject is received by the pixel, the SPAD cathode potential Vc drops, and the pixel output signal changes from “0” to “1”. Upon the pixel output signal becoming “1”, the output of the oscillation start/stop signal generation circuit 640 changes from “0” to “1”, and the oscillation switch 630 turns on. When the oscillation switch 630 is turned on, oscillation operation starts and a signal loop begins inside the oscillator as illustrated in FIG. 9. Every two signal loops inside the oscillator, the rising edge appears at the oscillator output, and the number of rising edges is measured by the oscillation count circuit 521. At time 803, the synchronous clock count circuit 531 stops counting and holds the value.

The timing at which the synchronization clock rises for the first time after the oscillator 511 is turned on is at time 805. Upon the rise of the synchronous clock, the output of the oscillation start/stop signal generation circuit 640 becomes “0” and the oscillation switch 630 turns off. At the timing when the oscillation switch 630 becomes “0”, oscillation is terminated and the internal signal of the oscillation circuit is held as it is. Since the oscillation is stopped, the counting of the oscillation count circuit 521 is also stopped.

As a result, the count result D_{Gelk} of the synchronous clock count circuit 531 is the value obtained by counting the time from time 801 to time 802 in 2⁷×t_{buff} hours. The count result D_{ROclk} of the oscillation count circuit 521 is the value obtained by counting the time from time 803 to time 804 in 24×t_{buff} hours. The internal signal D_{ROin} of the oscillator 511 is the value obtained by counting the time from time 804 to time 805 in time t_{buff}. After the following processing is performed on these signals, they are output to the signal processing unit 123 to complete one TDC operation.

The count result D_{ROclk} of the oscillation count circuit 521 and the oscillator D_{ROin} are added together using the following equation (2).

$${D}_{RO} = {2}^{4} \times {D}_{ROclk} + {D}_{ROin} \qquad ( 2 )$$

D_{RO} is the time from time 1804 to time 1805 counted in t_{buff}, and the time from time 802 to time 805 is the period of the synchronizing clock, which is equal to 2⁷×t_{buff}. Therefore, as represented by equation (3) below, D_{RO} is subtracted from the synchronization clock and added to D_{Gelk} to obtain the value D_{ToF}, which is the time-of-flight of the light (time from time 801 to time 803) counted in t_{buff}.

$$\begin{matrix}{D}_{ToF} = {2}^{7} \times {D}_{Gclk} + ( {2}^{7} - {D}_{RO} ) \\ = {2}^{7} \times {D}_{Gclk} + ( {2}^{7} - 24 \times {D}_{ROclk} - {D}_{ROin} )\end{matrix} \qquad ( 3 )$$

Since the delay time t_{buff} for one buffer stage varies depending on process factors such as transistor manufacturing errors, fluctuations in the voltage applied to the TDC circuit, and temperature, an oscillation adjustment voltage generating circuit 541 is arranged at each TDC.

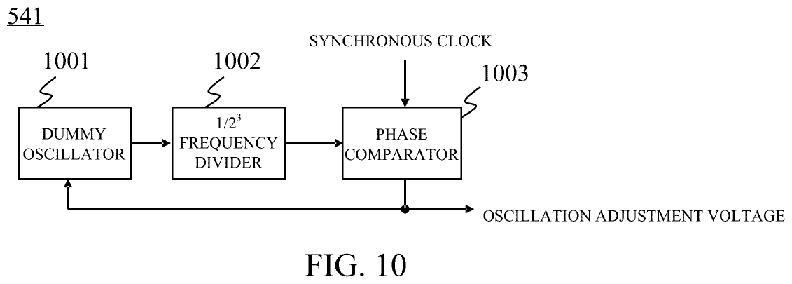

FIG. 10 is a block diagram of the oscillation adjustment voltage generating circuit 541. The oscillation adjustment voltage generating circuit 541 includes a dummy oscillator 1001, a 1/2³ divider 1002, and a phase comparator 1003. The dummy oscillator 1001 is the same oscillator as the oscillator 511 in the TDC 501.

The output of the dummy oscillator 1001 is input to the 1/2³ divider 1002. The 1/2³ divider 1002 is a circuit that outputs a clock signal with a clock frequency of 1/2³ of the input clock frequency. The synchronous clock and the output of the 1/2³ divider 1002 are input to the phase comparator 1003. The phase comparator 1003 compares the frequency of the synchronizing clock with the frequency of the output signal of the 1/2³ divider 1002. In a case where the frequency of the synchronizing clock is high, the output voltage is increased, and in a case where the frequency of the synchronizing clock is low, the output voltage is decreased. The output voltage of the phase comparator is input to the delay adjustment current source 620 of the oscillator to adjust the oscillator to a voltage at which the oscillator frequency is 2³ times the synchronous clock frequency.

Thus, the oscillation frequency is determined based on the synchronous clock frequency. Therefore, by generating the synchronous clock based on an external) IC that can output a constant frequency regardless of process/voltage/temperature changes, frequency variations due to process/voltage/temperature changes can be suppressed. For example, by inputting a clock of 160 MHz to the synchronous clock frequency, the oscillation frequency becomes 1.28 GHz, which is eight times the synchronous clock frequency. The delay time t_{buff} for one buffer stage, which is the time resolution, is 48.8 ps.

### Suppression of Reflected Light by the Beam Splitter

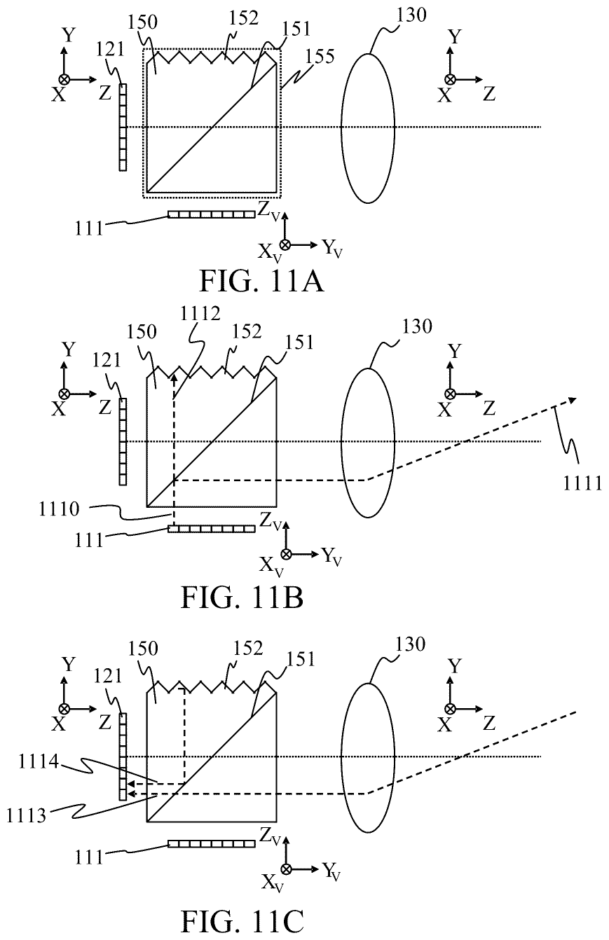

Next, referring to FIGS. 11A to 11C, the suppression of reflected light by the beam splitter 150 of this embodiment will be described. FIGS. 11A to 11C are configuration diagrams of a main part of the optical element 1 and illustrate cross sections of the beam splitter 150, the light emitting element array 111, the light receiving element array 121, and the imaging lens 130.

In FIG. 11A, the light emitting element array 111 and the light receiving element array 121 are conjugate via the half mirror 151 of the beam splitter 150, and each light emitting element and each light receiving element are also conjugate respectively. In FIG. 11A, both the light emitting element array 111 and the light receiving element array 121 are illustrated in a configuration of 8 rows, but the row number is not limited to this. In this embodiment, the light emitting elements and the light receiving elements are configured to have a one-to-one conjugate relationship, but it is not limited to this, and the number of the light receiving elements may be n×n times the number of the light emitting elements, and one light emitting element and n×n light receiving elements may be configured to have a conjugate relationship. The row numbers of the light emitting element array 111 are assigned in ascending order from the smaller Yv side to the larger Yv side in FIG. 11A. The row numbers of the light receiving element array 121 are assigned in ascending order from the smaller Y side to the larger Y side in FIG. 11A, and the light emitting element array 111 and the light receiving element array 121 with the same row number are in a conjugate relationship.

FIG. 11B illustrates an optical path of the light emitted from the light emitting element in row number 1 of the light emitting element array 111. A light ray 1110 emitted from the light emitting element array 111 is split into a light ray 1111 that is reflected by the half mirror 151 and irradiated onto the subject, and a light ray 1112 that passes through the half mirror 151 and proceeds toward the reflection suppression structure 152.

FIG. 11C illustrates reflected light 1113 from the subject and reflected light 1114 from the reflection suppression structure 152. The reflected light 1113 from the subject is incident on the light receiving element that is in a conjugate relationship with the light emitting element that emits the light.

The surface of the antireflection structure 152, on which the light ray 1112 is irradiated, uses a surface structure that is transparent, or absorbs, or both of them, so that the reflectance of the wavelength of light emitted from the light emitting element array 111 is low. The surface structure may be a laminated structure of dielectric materials having different refractive indices, or an anti-reflection structure made of a plurality of structures finer than the wavelength. It can also be an absorbing material such as a metal. The shape of the reflection suppression structure 152 is a periodic structure (e.g., rectangular shape) twice the interval between emission element points in the row direction of the light emitting elements, and the same shape in the paper depth direction of the cross-sectional view. It may also be a cylinder lens shape with a period of twice the interval of the light emitting elements. With the reflection suppression structure 152 having such a shape, the reflected light 1114 at the reflection suppression structure 152 is shifted by one row and enters the half mirror 151, and enters the light receiving element in a row that is not conjugate with the light emitting element that emitted the light.

As in a distance measurement process described below, of the light receiving elements, the pixel output of the light receiving element in the row conjugate with the row of the light emitting light that emitted light is output to the TDC. Therefore, the TDC detects the time from the time of light emission to the light incident on the light receiving element in the row conjugate with the row of the light emitting element, and does not respond to light incident on other rows. Therefore, false detection due to the light ray 1112 incident on the light receiving element that is not conjugate with the light emitting light that emits light can be suppressed. The aforementioned description for the first row is also true for the other rows.

### Distance Measurement Process

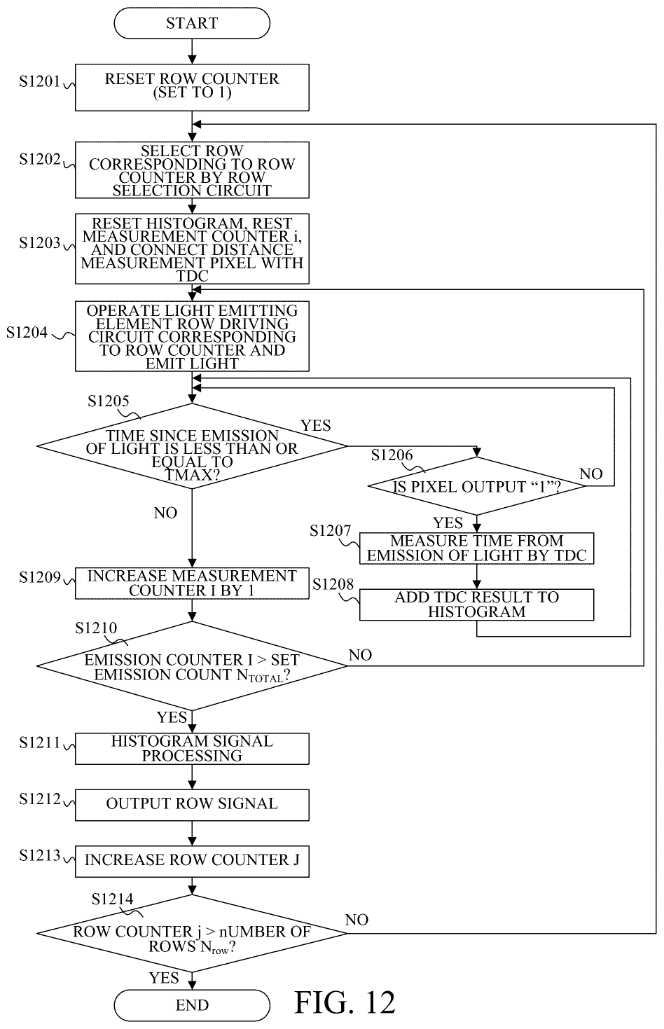

Next, referring to FIG. 12, the distance measurement process for acquiring 3D distance information using the optical apparatus 1 will be described. FIG. 12 is a flowchart illustrating the distance measurement process.

First, in step S1201, the general control unit 140 (the measurement control unit 124) resets a row counter j and sets it to 1. Subsequently, in step S1202, the measurement control unit 124 selects a row corresponding to the row counter using the row selection circuit 125, and sets the pixel signal of the corresponding row to be output to the TDC array unit 122 via the pixel output line 304. Subsequently, in step S1203, the measurement control unit 124 resets histogram circuits disposed in the signal processing unit 123 with the same number of the TDCs 501 and resets the measurement counter i.

Subsequently, in step S1204, the general control unit 140 (the light source control unit 114) operates the light emitting element row driving circuit 202 of the row corresponding to row counter j, and causes the light emitting element 201 belonging to the corresponding row to emit short pulse light. Subsequently, in step S1205, the light source control unit 114 determines whether the time since the emission of light is less than or equal to the time Tmax corresponding to the longest distance to be measured. In a case where it is determined that the time since the light emission is greater than time Tmax, the process proceeds to step S1209. On the other hand, in a case where it is determined that the time since the light emission is less than or equal to the time Tmax, the process proceeds to step S1206. In step S1206, the light source control unit 114 determines whether the pixel output is “1” or not. In a case where the pixel output is determined to be “1”, the process proceeds to step S1207. On the other hand, in a case where it is determined that the pixel output is not “1”, the process returns to step S1205. In other words, the process waits until the time since emission is greater than the time Tmax or the pixel output is “1”.

During the standby state, the light reflected back from the subject enters the light receiving element conjugate with the light emitting element that emitted the light. In a case where the pixel output signal becomes “1” due to reception of light, in step S1207, the general control unit 140 measures the time since the emission of the light using the TDC 501. Subsequently, in step S1208, the general control unit 140 stores (adds) the TDC result to the histogram and returns to the standby state again.

In a case where the time since the emission of light exceeds the time Tmax, in step S1209, the light source control unit 114 increases the emission counter i by 1. Subsequently, in step S1210, the light source control unit 114 determines whether the emission counter i is greater than the preset number of emission count Nₜₒₜₐₗ. In a case where it is determined that the emission counter i is smaller than the emission count Nₜₒₜₐₗ, the process proceeds to step S1204. On the other hand, in a case where the emission counter i is determined to be greater than the emission count Nₜₒₜₐₗ, the process proceeds to step S1211.

In step S1211, the measurement control unit 124 performs histogram signal processing to calculate a distance measurement result such as a measured distance, a signal strength, and a ambient light strength from the histogram of the TDC result. Subsequently, in step S1212, the measurement control unit 124 outputs the distance measurement result calculated in step S1211 from the measurement unit 120 (column signal output). Steps S1202 to S1212 complete the distance measurement process for one row, and the distance measurement result is output. Subsequently, in step S1213, the measurement control unit 124 increases the row counter j by 1.

Subsequently, in step S1214, the measurement control unit 124 determines whether the row counter j is greater than the number of rows N_{row} (N_{row}=8 in the case of FIG. 11). In a case where it is determined that the measurement counter j is less than or equal to the set number of times N_{row}, the process proceeds to step S1202, and the general control unit 140 performs the distance measurement process for the next row. On the other hand, in a case where the measurement counter j is determined to be greater than the set number of times N_{row}, the distance measurement process ends because the distance measurement process for all rows has been completed. With the above distance measurement process, a distance measurement result can be obtained in the form of a two-dimensional array such as image information.

In this embodiment, the light emitting element array 111 is made to emit light at different times for each row, and only the light emitting element of the row emitting light in the light emitting element array 111 and the light receiving element conjugated via the half mirror 151 are enabled. In the beam splitter 150, the reflection suppression structure 152 is provided on a surface opposite to the light emitting element array 111 across the half mirror 151. This enables the distance measurement process that suppresses false detection (false distance measurement) due to the reflected light.

### Second Embodiment

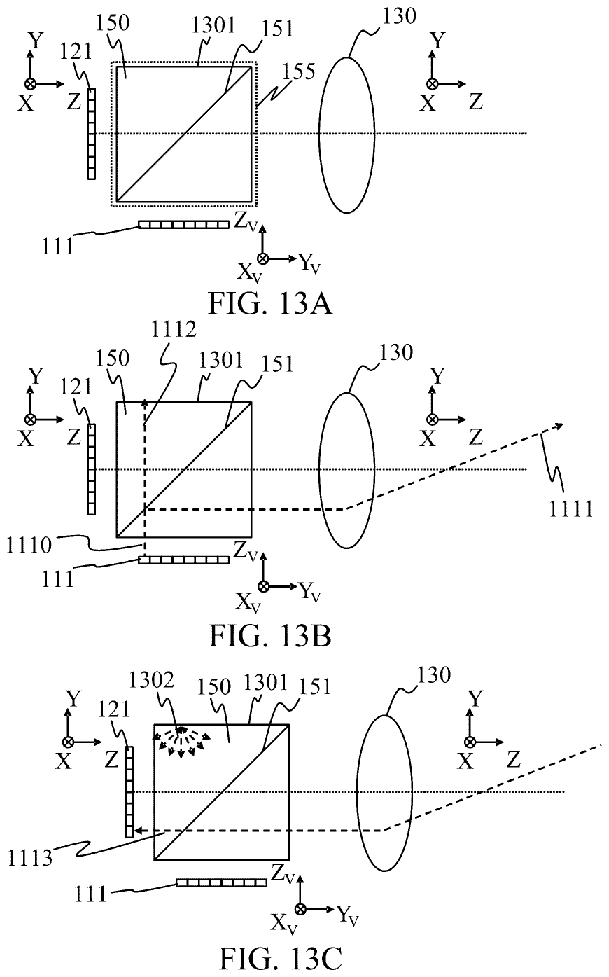

Next, referring to FIGS. 13A to 13C, a second embodiment of the present invention will be described. FIGS. 13A to 13C illustrate configuration diagrams of a main part of an optical apparatus (distance measuring apparatus) in this embodiment. This embodiment differs from the first embodiment in that a reflection suppression structure 1301 is provided instead of the reflection suppression structure 152. Other configurations are the same as in the first embodiment, therefore their descriptions are omitted.

FIG. 13A illustrates a cross-section of the beam splitter 150, the light emitting element array 111, the light receiving element array 121, and the imaging lens 130. FIG. 13B illustrates an optical path of the light emitted by the light emitting element of row number 1 of the light emitting element array 111. FIG. 13C illustrates reflected light 1113 from a subject and reflected light 1302 from the reflection suppressing structure 1301.

The reflection suppression structure 1301 in this embodiment is not a periodic structure of twice the period of the light emitting element 201, but a diffuse reflection surface with suppressed reflectivity. Diffuse reflection by the reflection suppression structure 1301 can suppress reflected light by the beam splitter 150 from entering the light receiving element conjugate with the light emitting element, thereby suppressing false distance measurement.

### Third Embodiment

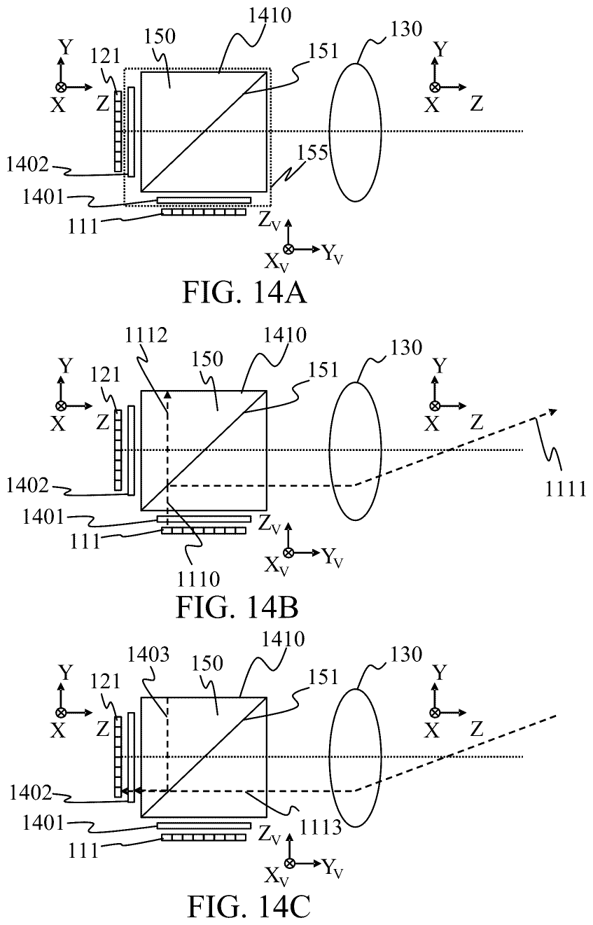

Next, referring to FIGS. 14A to 14C, a third embodiment of the present invention will be described. FIGS. 14A to 14C illustrate configuration diagrams of a main part of an optical apparatus (distance measuring apparatus) in this embodiment. This embodiment differs from the first and second embodiments in that polarization information of light is used to suppress light incidence to a light receiving element conjugate with the emitted light emitting element. In other words, in this embodiment, a polarizer (first polarizer) 1401 is disposed between the light emitting element array 111 and the beam splitter 150, and a polarizer (second polarizer) 1402 is disposed between the beam splitter 150 and the light receiving element array 121. Since other configurations are the same as those in the first and second embodiments, their descriptions are omitted.

FIG. 14A illustrates a cross-section of the beam splitter 150, the light emitting element array 111, the light receiving element array 121, the imaging lens 130, and the polarizers 1401 and 1402. The polarizer 1401 and the polarizer 1402, for example, constitute polarizers with mutually orthogonal orientations. FIG. 14B illustrates an optical path of light emitted by the light emitting element of row number 1 of the light emitting element array 111. The light that passes through the polarizer 1401 becomes light with linear polarization in an x direction (or y direction). FIG. 14C illustrates reflected light 1113 from a subject and an optical path 1403 of reflected light from the subject 1113 and from the surface 1410 of the beam splitter 150. The reflected light from the subject has less polarization. On the other hand, the reflection at the surface 1410 of the beam splitter 150 is light with linear polarization in the x direction (or the y direction) because of specular reflection. Part of the reflected light from the subject passes through the polarizer 1402. On the other hand, the reflected light from the surface 1410 of the beam splitter 150 does not pass through the polarizer 1402 and does not enter the light receiving element array 121.

In this embodiment, the polarizer 1401 is disposed between the light emitting element array 111 and the beam splitter 150, and the polarizer 1402 is disposed between the beam splitter 150 and the light receiving element array 121. This can suppress reflected light by the beam splitter 150 from entering the light receiving element array 121, thereby suppressing false distance measurement.

### Fourth Embodiment

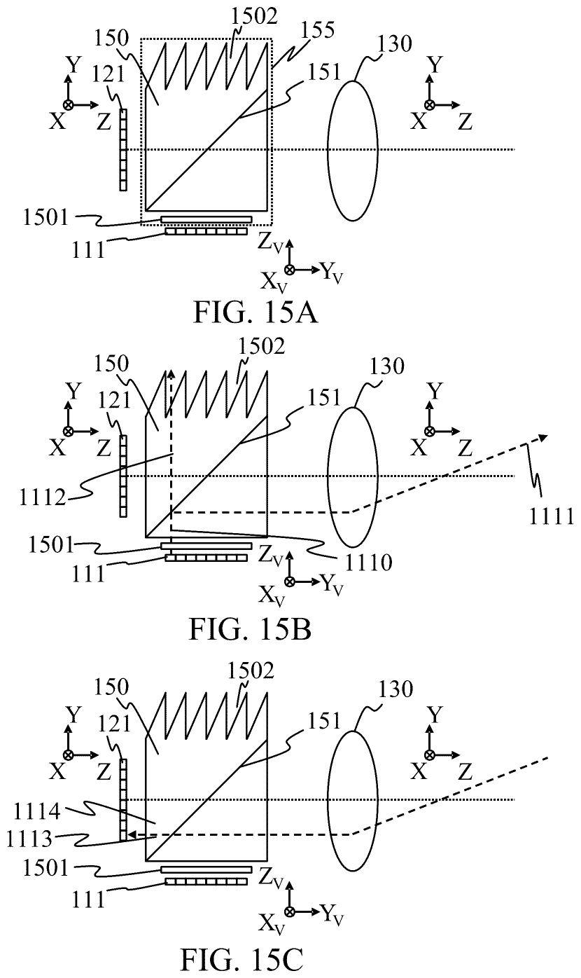

Next, referring to FIGS. 15A to 15C, a fourth embodiment of the present invention will be described. FIGS. 15A to 15C illustrate configuration diagrams of a main part of an optical apparatus (distance measuring apparatus) in this embodiment. This embodiment differs from the first to third embodiments in that polarization information of light and the reflection suppression structure 1502 of the beam splitter 150 are used to suppress light incidence to the light receiving element conjugate with the emitted light emitting element. In other words, in this embodiment, a polarizer 1501 is disposed between the light emitting element array 111 and the beam splitter 150, and the reflection suppression structure 1502 is formed on the beam splitter 150. Other configurations are the same as in the first to third embodiments, and therefore their descriptions are omitted.

FIG. 15A illustrates a cross-section of the beam splitter 150, the light emitting element array 111, the light receiving element array 121, the imaging lens 130, the polarizer 1501, and the reflection suppression structure 1502. The shape of the reflection suppression structure 1502 is a repeated structure of a plane parallel to the YZ plane and a plane oblique to the YZ plane at the same interval as the row direction interval of the light emitting elements. FIG. 15B illustrates an optical path of the light emitted by the light emitting element of row number 1 of the light emitting element array 111. FIG. 15C illustrates reflected light 1113 from a subject.

The polarizer 1501 is configured so that light passing through the polarizer 1501 is p-polarized light with respect to a plane oblique to the YZ plane constituting the reflection suppression structure 1502. The plane oblique to the YZ plane constituting the reflection suppression structure 1502 is set so that an angle between the normal of the plane and light ray 1112 after passing through the half mirror is Brewster's angle. This configuration makes it possible to suppress the reflection at the reflection suppression structure 1502.

### On-Board System

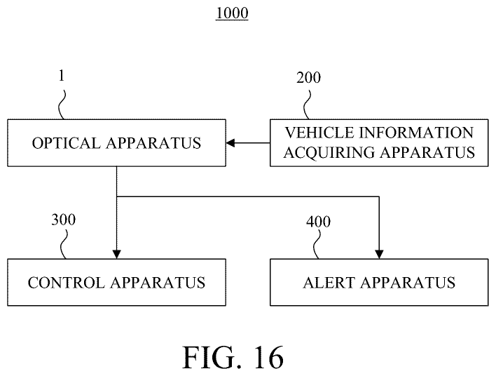

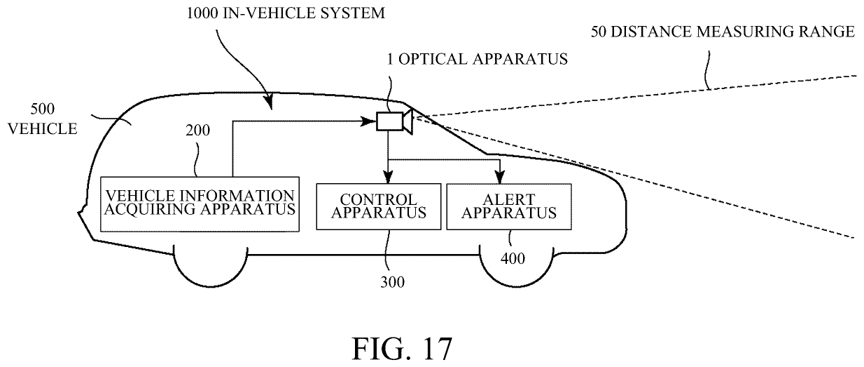

FIG. 16 is a configuration diagram of the optical apparatus 1 according to each embodiment and an on-board system (driving support apparatus) 1000 including the optical apparatus 1. The on-board system 1000 is a system held by a movable unit (movable apparatus) such as an automobile (vehicle), and configured to support the driving (operation) of the vehicle based on distance information to an object such as an obstacle and a pedestrian around the vehicle acquired by the optical apparatus 1. FIG. 17 is a schematic diagram of a vehicle 500 as a movable apparatus including the on-board system 1000. In FIG. 17, the distance measuring range (detection range) of the optical apparatus 1 is set to the front of the vehicle 500, but the distance measuring range may be set to the rear or side of the vehicle 500.

As illustrated in FIG. 16, the on-board system 1000 includes the optical apparatus 1, a vehicle information acquiring apparatus 200, a control apparatus (controller or electronic control unit (ECU)) 300, and an alert apparatus (alert unit) 400. In the on-board system 1000, the general control unit 140 in the optical apparatus 1 functions as a distance acquiring unit and a collision determining unit. However, if necessary, the on-board system 1000 may include a distance acquiring unit and a collision determining unit separate from the general control unit 140, or each may be provided outside the optical apparatus 1 (for example, inside the vehicle 500). Alternatively, the control apparatus 300 may be used as the general control unit 140.

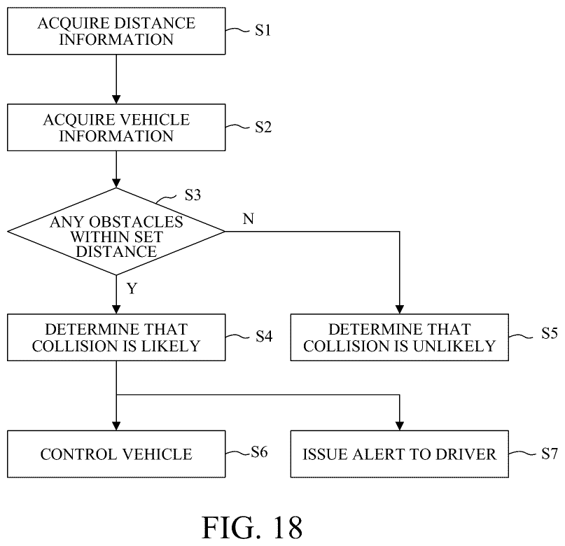

FIG. 18 is a flowchart illustrating an example operation of the on-board system 1000 according to this embodiment. A description will now be given of the operation of the on-board system 1000 with reference to this flowchart.

First, in step S1, the light source unit 113 in the optical apparatus 1 illuminates an object around the vehicle, and the light receiving element array 121 receives the reflected light from the object, and the general control unit 140 acquires distance information to the object based on the signal output by the light receiver 121. In step S2, the vehicle information acquiring apparatus 200 acquires vehicle information including the vehicle speed, yaw rate, steering angle, etc. In step S3, the general control unit 140 determines whether the distance to the object is within a previously set distance range using the distance information acquired in step S1 and the vehicle information acquired in step S2.

This configuration can determine whether an object exists within a set distance around the vehicle and a likelihood of collision between the vehicle and the object. Steps S1 and S2 may be performed in the reverse order to the above, or may be processed in parallel with each other. The general control unit 140 determines that there is a likelihood of collision (step S4) in a case where an object exists within the set distance, and determines that there is no likelihood of collision (step S5) in a case where there is no object within the set distance.

Next, in a case where the general control unit 140 determines that there is a likelihood of collision, it notifies (transmits) the determination result to the control apparatus 300 and the alert apparatus 400. At this time, the control apparatus 300 controls the vehicle based on the determination result of the general control unit 140 (step S6), and the alert apparatus 400 issues an alert to the user of the vehicle (driver, passenger) based on the determination result of the general control unit 140 (step S7). The notification of the determination result may be sent to at least one of the control apparatus 300 and the alert apparatus 400.

The control apparatus 300 can control the movement of the vehicle by outputting a control signal to the driving unit (engine, motor, etc.) of the vehicle. For example, it performs control such as applying the brakes in the vehicle, releasing the accelerator, turning the steering wheel, and generating a control signal that generates a braking force in each wheel to suppress the output of the engine or motor. In addition, the alert apparatus 400 issues an alert to the user, for example, by emitting an alert sound, displaying alert information on the screen of a car navigation system, etc., and applying vibrations to the seat belt or steering wheel.

As described above, the on-board system 1000 according to this embodiment can detect and measure a distance to an object by the above processing, and can avoid a collision between the vehicle and the object. In particular, applying the optical apparatus 1 according to each embodiment to the on-board system 1000 can achieve high distance measurement accuracy, and detect an object and determine a collision with high accuracy.

In this embodiment, the on-board system 1000 is applied to driving support (collision damage reduction), but this embodiment is not limited to this example, and the on-board system 1000 may be applied to cruise control (including adaptive cruise control function) and automatic driving. The on-board system 1000 is not limited to vehicles such as automobiles, but can be applied to movable units, such as ships, aircraft, and industrial robots. The on-board system 1000 is not limited to movable units, but is applicable to various devices that use object recognition, such as intelligent transport systems (ITS) and surveillance systems.

The on-board system 1000 and the vehicle (movable apparatus) 500 may include a notification apparatus (notification unit) for notifying the manufacturer (manufacturer) of the on-board system or the distributor (dealer) of the movable apparatus that the vehicle 500 has collided with an obstacle, if any. For example, the notification apparatus may be one that transmits information (collision information) regarding the collision between the vehicle 500 and an obstacle to a preset external notification destination by e-mail or the like.

A configuration in which the notification apparatus automatically notifies the collision information in this way can promptly take measures such as inspection and repair after the collision occurs. The notification destination of the collision information may be an insurance company, a medical institution, the police, or any other party arbitrarily set by the user. The notification apparatus may be configured to notify the notification destination of not only the collision information but also failure information regarding each part and consumption information regarding consumables. The presence or absence of a collision may be detected using distance information acquired based on the output from the light receiver 121, or may be detected by another detector (sensor).

### Other Embodiments

Embodiment(s) of the disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read-only memory (ROM), a storage of distributed computing systems, an optical disc (such as a compact disc (CD), digital versatile disc (DVD), or Blu-ray Disc (BD)™), a flash memory device, a memory card, and the like.

Each embodiment can provide a compact optical apparatus that is capable of reducing the influence of reflected light, on-board system, and movable apparatus.

While the disclosure has described example embodiments, it is to be understood that some embodiments are not limited to the disclosed embodiments. The scope of the following claims is to be accorded the broadest interpretation so as to encompass all such modifications and equivalent structures and functions.

What is claimed is:

1. An optical apparatus comprising:
a light emitting unit including a plurality of light emitting elements arranged in a two-dimensional shape;
a light receiving unit including a plurality of light receiving elements;
an imaging optical system;
a light division unit arranged between the imaging optical system and the light receiving unit, the light division unit including a reflector; and
an acquisition unit configured to acquire distance information of an object based on a time that is required from emission of light by the light emitting unit to reception of light reflected by the object by the light receiving unit,
wherein a light emitting element in a first row and a light emitting element in a second row of the plurality of light emitting elements emit light at different times from each other in a time-division manner,
wherein an optical axis direction of the imaging optical system and a normal direction of the reflector are not parallel,
wherein the light from the light emitting unit is reflected by the reflector to pass through the imaging optical system to be reflected by the object,
wherein light reflected by the object passes through the imaging optical system to transmit through the reflector to be received by the light receiving unit,
wherein a first light emitting element of the plurality of light emitting elements and a first light receiving element of the plurality of light receiving elements are in a conjugate relationship via the reflector, and
wherein the light division unit is configured to suppress light from the first light emitting element from entering the first light receiving element.

2. The optical apparatus according to claim 1,
wherein the light division unit includes a beam splitter including the reflector,
wherein the beam splitter includes a reflection suppression structure on a surface opposite to a surface that faces the light emitting unit, and
wherein the reflection suppression structure suppresses light that is emitted from the first light emitting element and that transmits through the reflector and that is reflected by the reflection suppression structure from entering the first light receiving element.

3. The optical apparatus according to claim 2, wherein the reflection suppression structure is a periodic structure with a period twice an interval of the plurality of light emitting elements.

4. The optical apparatus according to claim 3, wherein the reflection suppression structure has a row-direction cross section of the plurality of light emitting units having a same shape, and a column-direction cross section having the periodic structure with the period twice the interval of the plurality of light emitting elements.

5. The optical apparatus according to claim 3, wherein the periodic structure has a rectangular shape.

6. The optical apparatus according to claim 3, wherein the periodic structure has a cylinder lens shape.

7. The optical apparatus according to claim 2, wherein the reflection suppression structure includes a multilayer film that transmits a wavelength of the light emitted from the light emitting unit.

8. The optical apparatus according to claim 2, wherein the reflection suppression structure has a plurality of structures that are finer than a wavelength of the light emitted from the light emitting unit.

9. The optical apparatus according to claim 2, wherein the reflection suppression structure includes an absorbing material that absorbs a wavelength of the light emitted from the light emitting unit.

10. The optical apparatus according to claim 1,
wherein the light division unit includes:
a beam splitter including the reflector,
a first polarizer arranged between the light emitting unit and the beam splitter, and
a second polarizer arranged between the light receiving unit and the beam splitter, and
wherein the first polarizer and the second polarizer extinguish the light that is emitted from the light emitting unit and that is reflected by a surface of the beam splitter opposite to a surface facing the light emitting unit.

11. The optical apparatus according to claim 1,
wherein the light division unit includes:
a beam splitter including the reflector, and
a first polarizer arranged between the light emitting unit and the beam splitter,
wherein light transmitted through the reflector from the light emitting unit is p-polarized light with respect to a surface opposite to a surface facing the light emitting unit across the reflector in the beam splitter, and
wherein an angle between the light passing through the reflector and a normal of a surface opposite to a surface facing the light emitting unit in the beam splitter is the Brewster's angle.

12. An on-board system comprising the optical apparatus according to claim 1, wherein the on-board system determines a likelihood of collision between a vehicle and the object based on the distance information to the object obtained by the optical apparatus.

13. The on-board system according to claim 12, further comprising a control apparatus configured to output a control signal to generate a braking force in the vehicle in a case where it is determined that there is a likelihood of collision between the vehicle and the object.

14. The on-board system according to claim 12, further comprising an alert apparatus configured to issue an alert to a user of the vehicle in a case where it is determined that there is a likelihood of collision between the vehicle and the object.

15. The on-board system according to claim 12, further comprising a notification apparatus configured to notify an external party of information regarding the collision between the vehicle and the object.

16. A movable apparatus comprising the optical apparatus according to claim 1, wherein the movable apparatus is movable while holding the optical apparatus.

17. The movable apparatus according to claim 16, further comprising a determining unit configured to determine a likelihood of collision with the object based on the distance information to the object acquired by the optical apparatus.

18. The movable apparatus according to claim 17, further comprising a control unit configured to output a control signal for controlling movement of the movable apparatus in a case where it is determined that there is the likelihood of collision with the object.

19. The movable apparatus according to claim 17, further comprising an alert unit configured to issue an alert to a user of the movable apparatus in a case where it is determined that there is the likelihood of collision with the object.

20. The movable apparatus according to claim 17, further comprising a notification unit configured to notify an external party of information regarding the collision with the object.
